(19) United States
(12) Patent Application Publication
(10) Pub. No.: US 2012/0171650 A1
(43) Pub. Date: Jul. 5, 2012

(54) METHODS AND SYSTEMS FOR DEVELOPING MEDICAL WAVEFORMS AND TRAINING METHODS

(76) Inventors: Adrian F. Warner, Wauwatosa, WI (US); Daniel Schneidewend, Wauwatosa, WI (US); Linda Helvick, Wauwatosa, WI (US); Payam Karbassi, Wauwatosa, WI (US)

(21) Appl. No.: 12/980,854

(22) Filed: Dec. 29, 2010

(51) Int. Cl. G09B 23/28

(52) U.S. Cl. 434/262

(57) ABSTRACT

The present technology relates to a medical waveform development system comprising a medical waveform recording system for obtaining recorded medical waveforms. The system further comprises a physiological simulator for accessing recorded medical waveforms and for processing modified medical waveforms. The system also comprises an invasive workbench that allows a user to access the recorded medical waveforms and modified medical waveforms via software applications that are accessible on a computer.

### RELATED APPLICATIONS

[Not Applicable]

### BACKGROUND OF THE INVENTION

The present technology relates to methods and systems for processing and simulating medical waveforms. More specifically, the present technology relates to methods and systems for collecting and using cardiac physiological data to support electrophysiological research, training and development.

Electrophysiology is an instrumental tool in the ongoing development of cardiac science. The study of fundamental underlying mechanisms, processes and attributes of the heart is a rapidly growing field. In the past decade, an increasing number of publications have highlighted the importance atria fibrillation, an arrhythmia that can lead to stroke and death. Various methods to treat this condition exist, ranging from drug therapy to cardiac ablation. The growth and interest in this field has been explosive, and new methods continue to develop, evolve and become refined.

Two fundamental problems exist that thwart the growth of cardiac study. First, the underlying mechanisms of the human heart remain a source of considerable speculation and research. Second, there is a worldwide shortage of electrophysiologists skilled in the delivery of therapeutic care. There thus exists a need to for a systemic approach that supports cardiac research and also aids in the practical training, development and growth of electrophysiologists and the clinical research and support staff.

### BRIEF SUMMARY OF THE INVENTION

The present technology relates to a medical waveform development system comprising a medical waveform recording system for obtaining recorded medical waveforms. The system further comprises a physiological simulator for accessing recorded medical waveforms and for processing modified medical waveforms. The system also comprises an invasive workbench that allows a user to access the recorded medical waveforms and modified medical waveforms via software applications that are accessible on a computer.

The present technology also relates to a medical waveform development system comprising a physiological simulator for accessing recorded medical waveforms and for processing modified medical waveforms. The physiological simulator allows for user modification of the recorded medical waveforms. The physiological simulator also comprises a media transfer device for importing and exporting medical waveforms. The system also comprises an invasive workbench that allows a user to access the recorded medical waveforms and modified medical waveforms via software applications that are accessible on a computer. The system can receive medical waveforms from a variety of sources, process the waveforms, and access them on the invasive workbench.

The present technology also relates to a method for developing medical waveforms. The method comprises obtaining a medical waveform with a medical waveform recording system. The medical waveforms are then imported into a physiological simulator, where the physiological simulator processes the medical waveforms to generate modified medical waveforms. The medical waveforms are exported to a storage location, where the medical waveforms can be accessed via an invasive workbench. The invasive workbench implements the modified medical waveforms into software applications within the invasive workbench framework. The software applications can include an algorithm development tool, a statistical analysis tool, a search tool and/or a publishing tool.

### BRIEF DESCRIPTION OF SEVERAL VIEWS OF THE DRAWINGS

FIG. 1 depicts an exemplary schematic of one embodiment of a waveform development system according to one embodiment of the present technology.

FIG. 2 depicts a schematic diagram of a physiological simulator operating in connection with a medical waveform recording system according to one embodiment of the present technology.

FIG. 3 depicts a schematic diagram of an invasive workbench working in connection with a physiological simulator in accordance with one embodiment of the present technology

FIG. 4 depicts an example view of a navigation window of the invasive workbench feature in accordance with one embodiment of the present technology.

FIG. 5 depicts an exemplary view of a study view window of the invasive workbench feature in accordance with one embodiment of the present technology.

FIG. 6 depicts an exemplary view of an algorithm window of the invasive workbench feature in accordance with one embodiment of the present technology.

FIG. 7 depicts an exemplary diagram of the functionality associated with the invasive workbench in accordance with one embodiment of the present technology.

FIG. 8 depicts a flow diagram of a method in accordance with one embodiment of the present technology.

### DETAILED DESCRIPTION OF THE INVENTION

The present technology relates to methods and systems for collecting and using cardiac physiological data to support electrophysiological research, training and development. For example, the present technology describes a system that incorporates various tools to use in conjunction with cardiac equipment for providing teaching, training and development applications for electrophysiologists.

Cardiac mapping system simulators that exist on the market today serve to simulate the electrical signal propagation of a heartbeat as it moves across the surface of a heart. For example, U.S. Pat. No. 5,041,973 describes a cardiac mapping system simulator that generates a series of impulses that mimic the electrophysiological waveform are forming a two-dimensional map depicting heart activity. The waveforms collected may be electrocardiogram (ECG) waveforms, intra cardiac waveforms, or pressure waveforms, for example. Other cardiac equipment presently on the market includes the CardioLab, a product line manufactured by GE Healthcare that collects cardiac waveforms along with other patient and medical data and/or information. The present technology may be designed to work with, or be incorporated into the aforementioned cardiac equipment, or other medical equipment involved in collecting waveforms, to provide teaching, training and other development tools in the field of study.

The present technology relates to a framework that supports the development of algorithms, particularly algorithms that can be applied to medical waveforms. The developed algorithms may include, for example, a combination of multiple forms of data, such as medical waveforms, patient data and medical imaging data. This framework supports the ability to review and select cardiac physiological data. It should be noted that though the primary focus of the present description will revolve around cardiac and related data, the present technology can also be used in alternative fields of study that generate waveform data. For example, the present technology can be used with algorithms and waveforms of the brain. Through the presently described framework, data can be loaded into an algorithmic research environment to store and execute user created algorithms outside of the clinical procedure. Multiple algorithmic models can be executed on the same data thus exploring the potential performance, optimizations, and function of various algorithms relative to real physiological data collected on a physiological recorder.

Certain embodiments of the present technology provide a physiological replay system. The physiological replay system component allows a user to replay collected physiological signals through a computer regeneration tool to replicate the original recorded signals and allow the signals to be reacquired using the physiological recorder. This feature provides resources for testing equipment and/or for testing users through a regenerated patient signal source. The replay system may also be used for real time performance testing of developed algorithms by allowing the data to be streamed through the physiological recorder. By reacquiring data, the original recorded data may be transformed through various signals processing methodology.

A workbench extension (or module) of the present technology allows for real time testing of algorithms embedded in the target real time environment. The workbench extension statically develops and tests algorithms, and in certain embodiments, exports the algorithms to an external test bed outside of the development framework. The ability of the physiological recorder to provide a real time data stream enables the algorithm to be tested, thereby assuring a high degree of correlation between the original test bench algorithm and the real time embedded algorithm.

This present technology allows full algorithmic development using the workbench framework through to real time targeted testing. However, the physiological recorder can also host new algorithmic developments in real time without impairing the integrity of the core platform that includes the integrated features of a physiological recorder, a playback system and a workbench framework. Thus, users may investigate experimental methodologies while maintaining the core regulatory compliance of the host physiological recorder. The ability to concurrently perform established clinical procedures, while simultaneously executing approved clinical experimental protocols enables controlled development of new algorithms in a controlled clinical environment.

The selection of physiological data can be used to create a wide range of cardiac (or other) replay files. These files may be introduced into a physiological replay system where the waveforms are supplied to a cardiac recorder through the hardware, for example, the same front-end hardware used during the original acquisition. The present technology provides a unique ability for a user to create simulation files. Moreover, the present technology also provides novel features by allowing the user to select cardiac waveform cycles and link, join or morph various waveform signals together to create a synthetic cardiac physiological waveform train. For example, a user of the present technology can create a fabricated or synthetic waveform comprised of multiple cardiac waveforms that are each collected from a separate source, but when combined can generate an authentic waveform signal that depicts cycles that are otherwise unobtainable from a single waveform.

The synthetic waveforms, or cases, can be executed in a repetitive manner if desired. For example, numerous cycles can be linked to create case equivalent data sets lasting many hours without repetition. Thus, a full patient care cycle may be simulated. Moreover, complications, unusual features and dangerous scenarios can also be reused or synthesized by the end user. In certain embodiments, waveforms may be provided with other patient data, such as patient age, gender, height, weight and medical conditions, for example.

A further enhancement to the present technology system is the ability to create event triggers that are associated with the simulated waveform case files. The event triggers can initiate related actions to the current physiological simulation. Examples of event triggers may include, but are not limited to, the following: (1) an instructional presentation (e.g., a Power Point presentation) that provides instructional information related to the presently simulated waveform; (2) a clinical test question posed to the user, for example, the user may be asked what meds should be administered to the simulated subject based on the simulated waveform; (3) a presentation providing additional information about the patient, for example, a presentation that displays simulated patient age, gender and weight to correspond with the simulated waveform; (4) initialization of image files related to the case, for example, images depicting catheter placement, ablation replay data and/or simulated real-time vitals replay data; (5) a research assistance tool providing access to various literature or other research engines that corresponding with issues generated by the simulated waveform; (6) a publication assistant tool providing access to research tools and word processing applications; and/or (7) a statistical analysis tool.

In certain embodiments of the present technology, the event triggers can facilitate the ability to randomize waveform case data following logical case trees. For example, the user may associate results of an event trigger, a specific selection or a random selection from a set to move to the next phase. Certain embodiments of the present technology include the ability to insert aberrant data into captured waveforms such as white noise, synthetic baseline wander, and electrical interference patterns.

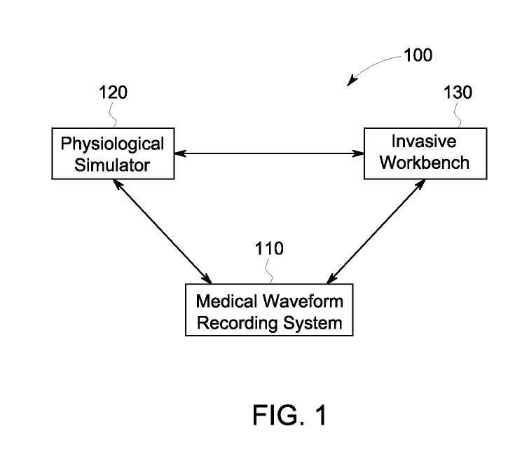

The present technology provides various hardware and software tools that work with cardio or other medical equipment. FIG. 1 depicts an exemplary schematic of one embodiment of a medical waveform development system 100 according to the present technology. The medical waveform development system 100 comprises three units working in conjunction with each other: (1) a medical waveform recording system 110, (2) a physiological simulator 120; and (3) an invasive workbench 130. The medical waveform recording system 110 may be any recording system presently used to record various waveforms. For example, medical waveform recording system 110 may be CardioLab, an electropysiology recording system manufactured by GE Healthcare, or it may be Mac-Lab, a cardiac catherization lab recording system manufactured by GE Healthcare. The medical waveform recording system 110 may also be a combination lab that employs elements of both Mac-Lab and CardioLab applications. Alternatively, in certain embodiments, the medical waveform recording system 110 may be another type of EP recorder used to record and/or measure medical waveforms. For example, the medical waveform recording system 110 may be another type of cardio waveform recorder, or it may be a brain waveform recording system. In certain embodiments, the medical waveform recording system 110 is capable of recording all types of medical waveforms. For example, the medical waveform recording system 110 can record ECG waveforms, intra cardiac waveforms or pressure waveforms. However, in certain embodiments, the medical waveform development system 100 of the present technology may include a medical waveform recording system 110 that is designed to specifically record a certain type of medical waveform, for example, a cardiac waveform. In certain embodiments, the medical waveform recording system 110 may not be included in the medical waveform development system 100, the system 100 instead importing medical waveforms from alternative sources.

The medical waveform recording system 110 may also capture other information in addition to medical waveforms. For example, the medical waveform recording system 110 can capture patient information such as patient age, height, weight, medical history and other information. This information can be exported along with the medical waveforms to assist in algorithm development and in generating training and teaching tools, for example.

Connected to the medical waveform recording system 110 is a physiological simulator 120. The physiological simulator 120 captures and replays signals recorded and/or generated by the medical waveform recording system 110. In certain embodiments, the physiological simulator 120 replays surface ECG signals. The physiological simulator 120 can also replay data sets resembling clinical studies. Users may operate the physiological simulator 120 to chain, or link together various recorded waveforms to create a single, fabricated or synthetic sequenced waveform composed of actual waveform signals. This feature allows a user to generate unique waveform scenarios based on actual recorded medical waveform is for training or other purposes that would otherwise be very difficult or impossible to generate. Further, the physiological simulator 120 may be capable of replaying hemodynamic signals. The physiological simulator 120 may also display other information received from the medical waveform recording system 110, such as patient data, for example. Examples of patient data can include, images, ablation data and vitals information, for example.

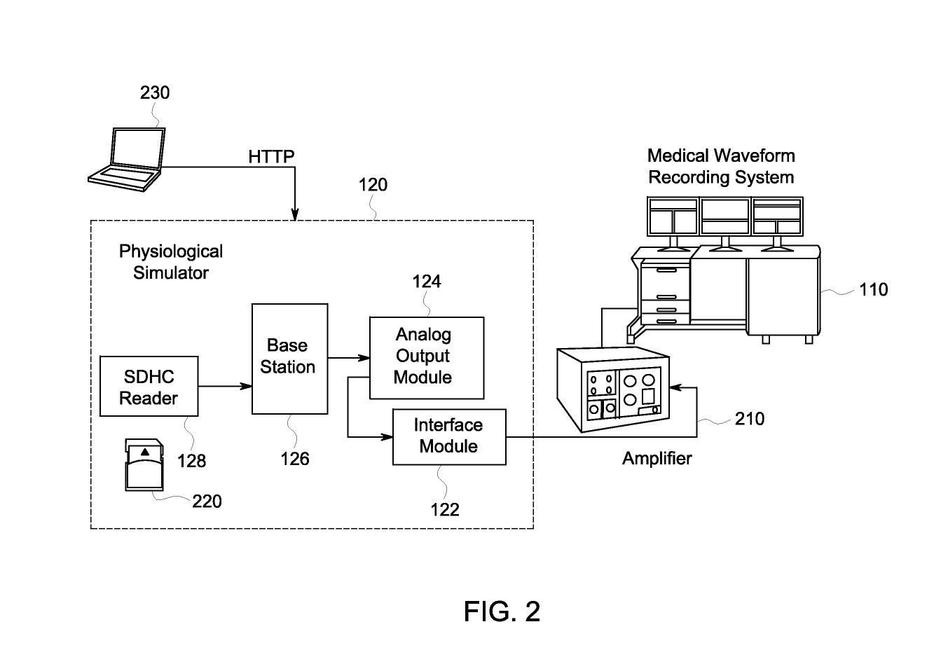

FIG. 2 depicts a schematic diagram of the physiological simulator 120 operating in connection with the medical waveform recording system 110. The medical waveform recording system 110 is depicted as a terminal workstation, such as the CardioLab system described above. The physiological simulator 120 is connected to an amplifier 210, which amplifies the signal recorded by the medical waveform recording system 110. Amplifier 210 may be, for example, a CardioLab amplifier. The physiological simulator 120 can be connected to a computer workstation 230 by any connection method, for example, by way of a network connection, via the internet, via a direct link. Alternatively, the physiological simulator 120 can store information using a removable media tool, such as an SD card 220, a CD-Rom, or a thumb drive, for example. In certain embodiments, the physiological simulator 120 may be a software application that is installed and accessed directly on the computer workstation 230, and is connected via a network or other resources to the medical waveform recording system 110.

The physiological simulator 120 comprises a base station 126. The base station 126 provides power and signal handling for the physiological simulator 120. The functionality of the simulator is operated through a user interface displayed on the computer workstation 230, which interface may be stored on base station 126. An analog output module 124 operates with an interface module 122 to display and provide information to the user, and to allow a user to interactively work with the displayed data. Interface module 122 supplies the waveform data to the amplifier. A connection between the interface module 122 and the amplifier 210 allows the signals to be displayed on the medical waveform recording system 110, however the interface operated on the computer workstation 230 physically controls the operation and replay of the data sets that stored on physiological simulator 220. For example, the user may interact with the physiological simulator 120 via the interface module 122 to collect portions from various waveforms and to assemble a fabricated or synthetic sequenced waveform for training or other purposes. The physiological simulator 120 also comprises an SDHC reader 128 or another input mechanism (e.g., a CD-Rom, a USB port, etc.) that allows for data to be brought into the simulator from another source. For example, a user may collect a medical waveform from a medical waveform recording system that is remote to the medical waveform development system 100, and load the medical waveform into the physiological simulator 120 for study, manipulation or other use by a user.

A user may obtain medical waveforms and view the medical waveforms in real-time via the physiological simulator 120. The user may also modify the medical waveforms, and create new medical waveforms via the invasive workbench 130. For example, a user may add markers to the medical waveforms, such that when viewed later by a user (for example, using the invasive workbench 130), when the simulated medical waveform reaches the marker, certain pre-programmed events occur. The pre-programmed events may provide an explanation related to the medical waveform, pose questions or training tips to the user, or may launch applications to assist the user in research, publication, statistical analysis or algorithm development objectives, for example.

Physiological simulator 120 as described herein can be uses as a simulator; however, unlike conventional simulators, the waveforms used herein can be derived from real patients with real cardiac diseases and anomalous conditions. Accordingly, the degree of variance can be large, as the only limitation on the variance is the availability of actual case studies to extract data from. These cases may be used in their entirety, or synthetically by linking cardiac cycles together to form a new case. Thus, even the synthetic cases are derived from actual physical data. In certain embodiments, the acquired data may be “cleaned up” or filtered after, or during the original recording. For example, a filter may be employed to remove portions of the signal attributed to background noise. In certain embodiments, the recorded waveforms can be adulterated through inclusion of noise or artifact, for example, as part of an experimental system. Accordingly, unlike conventional simulator, the presently described physiological simulator 120 utilizes more than the conventional example canned or synthesized waveforms.

Referring back to FIG. 1, an invasive workbench 130 is depicted as the third element of the medical waveform development system 100 of the present technology. The workbench 130 provides an interactive interface allowing a user to operate various functionalities that can use the medical waveforms recorded and simulated by the medical waveform recording system 110 and the physiological simulator 120.

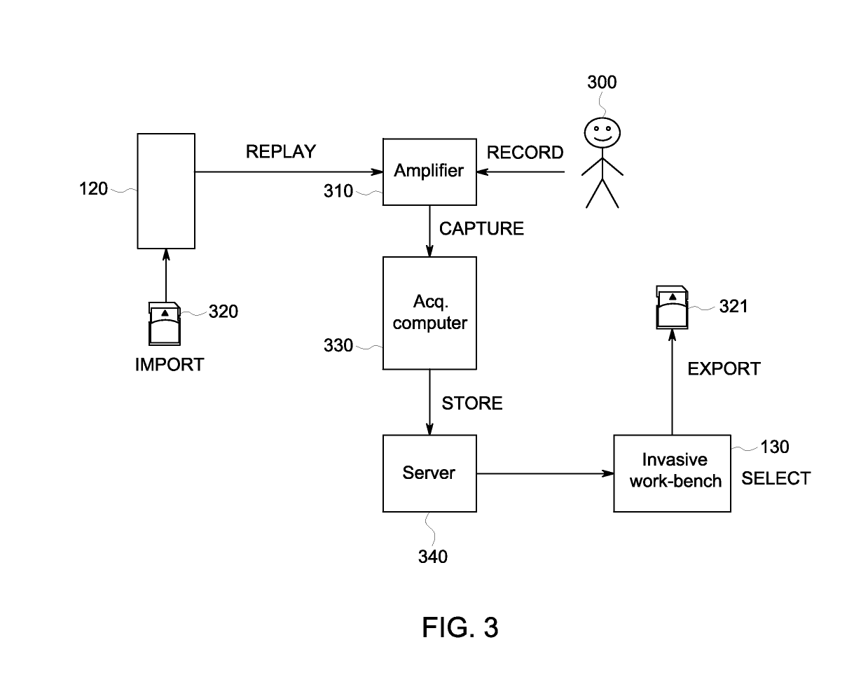

FIG. 3 depicts a schematic diagram of the invasive workbench 130 working in connection with the physiological simulator 120: The physiological simulator 120 obtains medical waveforms and/or other patient or medical data and information recorded from a patient 300 recorded by a medical waveform recording system (not shown). In certain embodiments the waveform signal may be amplified by amplifier 310. Alternatively, medical waveforms and information may be imported into the physiological simulator 120 via a media or data transfer mechanism, such as an SD card 320, for example. The physiological simulator 120 may simulate the recorded waveforms, or be used to modify and generate fabricated or synthetic waveforms by a user via an interface on a computer, for example, the acquiring computer 330. The acquiring computer 330 stores waveforms onto a server 340, which may be accessed by the acquiring computer 330, or another computer that may be connected to the server 340. Other patient and medical data and information may be stored on the server 340 as well, and the data and information may correspond to certain waveforms. An acquiring computer 320 serves as a resource for interacting with the physiological simulator 120, and stores information on a server 340.

The invasive workbench 130 may access the server 340 via a computer through a network, for example, and may access the waveforms and other information stored on the server. The invasive workbench 130 provides a resource for teaching, training or working with the medical data, including the medical waveforms and other information. For example, the invasive workbench may provide simulated situations to training physiologists, and provide interactive applications as a teaching and training tool. The invasive workbench may export data, training sessions, or other information for use at another workstation or at another time via a media transfer device, such as via an SD card 321, a CD-ROM, a thumb drive, the internet or other data transfer mechanisms.

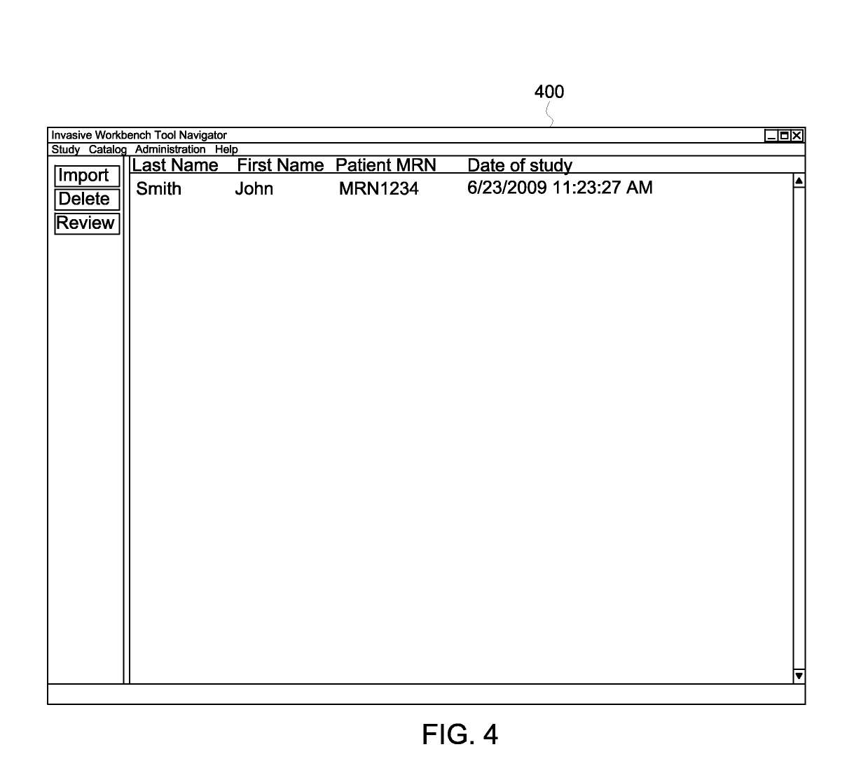

FIGS. 4-7 depict exemplary situations of an invasive workbench embodiment as employed by the present technology. FIG. 4 depicts an example view of a navigation window 400 of the invasive workbench. The navigation window 400 provides a list of various patients or other data sets, and provides tools for importing, deleting and reviewing the data sets.

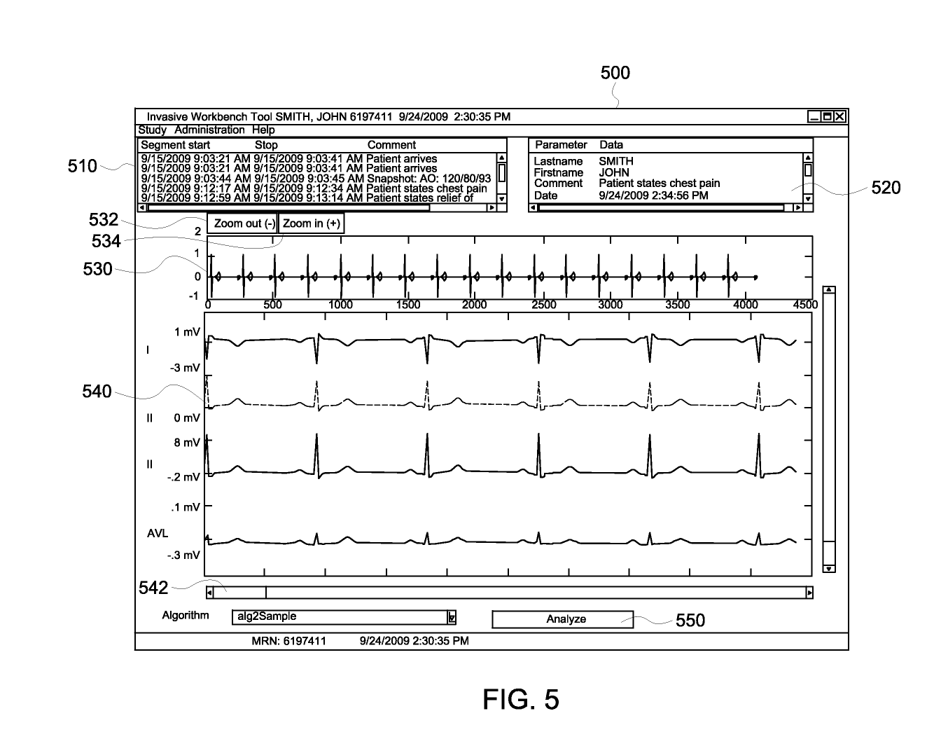

FIG. 5 depicts an exemplary view of the invasive workbench of the present technology in a study view 500 embodiment. Study view 500 depicts the various data sets in window 510. Patient information window 520 depicts information associated with the patient for which the present medical waveform and data set pertains. For example, the patient information window 520 can depict the patient's name, the date the medical waveform was obtained, and other comments relating to the patient's treatment. Compressed signal window 530 and waveform view window 540 depict the waveform signal from various viewpoints. A zoom out button 532 and a zoom in button 534 allow the user to view the waveform signal from a broader or narrower (and thus more detailed) fashion as the user sees fit. In FIG. 5, the waveform signal in the compressed signal window 530 depicts the waveform signal in its entirety, while the waveform view window 540 depicts a “zoomed in” view of the waveform signal (or signals), providing more detail. The compressed signal window 530 depicts the medical waveforms along various vertical pixels offset from each other. This view can be useful, for example, for identifying the earliest activation rate of the waveform. Scroll bar 542 on the waveform view window 540 allows the user to navigate along the waveform signal. An analyze button 550 may provide access to another functionality of the invasive workbench. A user may select the analyze button 550 to have access to an analysis tool that provides a statistical analysis of the waveform.

In certain embodiments, the study window 500 is patient-centric. That is, the window displays information on a patient by patient basis. For example, a user may elect a particular patient data set from the navigation window 400 depicted in FIG. 4. After selecting the data set, the invasive workbench imports the medical waveform signals and other information that is associated with that patient, which can be derived from multiple cardiac studies performed at separate dates and times, for example. From the study view window 500, the user can have access to various functionalities, for example, the analyze function 550. The user may also navigate from the study window 500 back to the navigation window 400 to obtain other data sets. In certain embodiments, various event triggers can generate functionality, or launch applications in the study view embodiment. For example, an event trigger may correspond with a marker placed relative to the medical waveform by a user using the physiological simulator 120. The event trigger may open an application, such as a Power Point presentation, for example, that provides teaching lessons, or poses training questions to the user based on the presently viewed waveform. Event triggers may also launch applications or functionality that requires the user to complete various tests, solve problems, draft reports, conduct research, analyze data or complete other tasks related to research, study, training or medical waveform development, for example.

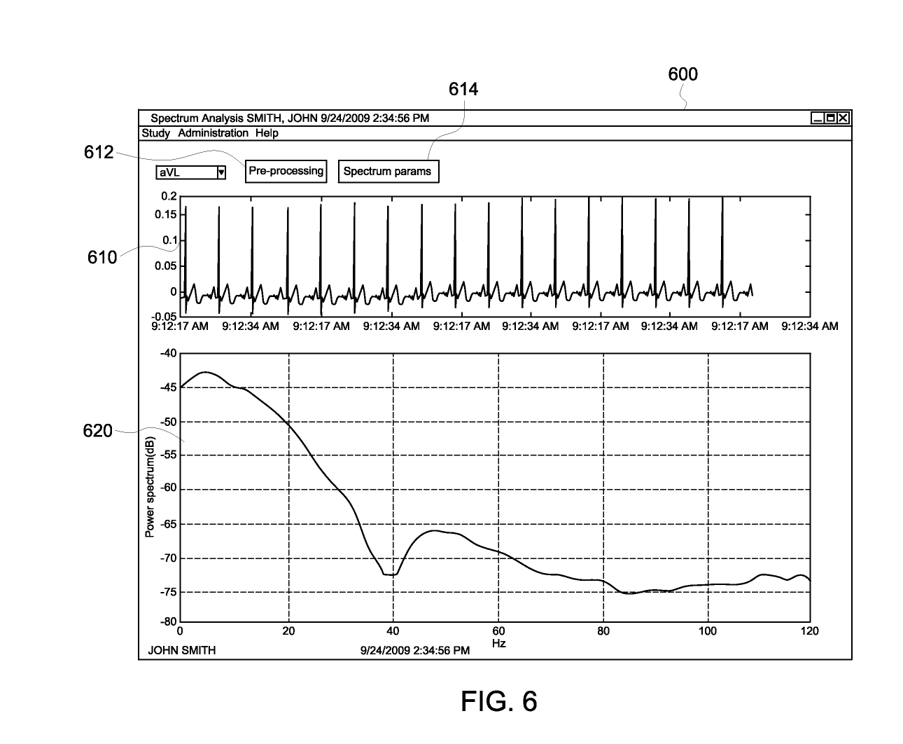

FIG. 6 depicts an embodiment of the invasive workbench in an algorithm 600 window setting. The algorithm window 600 depicts various algorithms and waveforms and provides resources for processing and interacting with the algorithms and waveforms. A waveform display window 610 depicts the selected waveform, while a chart window 620 charts other features corresponding to the waveform. For example, chart window 620 depicts the power spectrum corresponding with the waveform depicted in the waveform display window 610. The algorithm window 600 executes an additional application or functionality that is operated by the medical waveform development system 100 of the present technology. In the algorithm window 600, the user can view a data-segment, or waveform segment that is selected while in the study window 500. The algorithm or waveform can be developed by researchers, and may be assembled from a variety of various waveforms taken from various sources. In certain embodiments, the algorithm is developed using the physiological simulator 120 of the present technology. The algorithm may be derived from a waveform recorded by medical waveform recording system 110, or it may be a fabricated or synthetic waveform generated from a plurality of recorded waveforms. In other embodiments, the algorithm is obtained from alternative sources and imported into the invasive workbench 130.

The algorithm window may provide access to other functionality by way of buttons. For example, the algorithm window 600 may provide a pre-processing button 612, or a spectrum parameters button 614, allowing the user to access and modify other information pertaining to the viewed waveform. The user may also navigate from the algorithm window 600 back to the navigation window 400 to obtain other data sets.

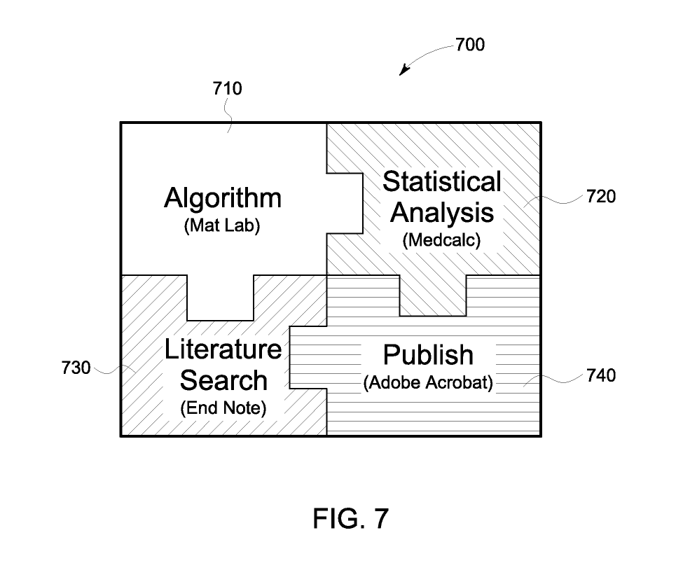

FIG. 7 depicts an exemplary diagram 700 of the functionality that can be associated with the invasive workbench. The invasive workbench feature may comprise an algorithm application 710, for example, an application such as Mat Lab or a similar product. The workbench may also include a statistical analysis tool, 720. The statistical analysis tool 720 may be similar to available products such as Medcalc, for example. The workbench also comprises a literature search feature 730, for example, a program such as End Note or a similar product. The workbench also includes a publication tool 740 assisting the user to publish the research results obtained through the workbench. For example, the workbench may provide access to a program such as Adobe Acrobat that allows the user to publish results in a readable, printable and transferable format. These four features operate in conjunction, and along with the physiological simulator 120 and the medical waveform recording system 110, provide a tool that assists in the research, training and development of electrophysiology. In addition the tools depicted in FIG. 7, the present technology may incorporate various other tools, applications and software into the invasive workbench. For example, the invasive workbench may incorporate presentation software such as Power Point, internet browser access, training software, and communication and networking tools such as email and conferencing software.

The invasive workbench allows users to develop innovations and new algorithms, to publish experimental results, to teach and train users, and to validate hypotheses. The workbench provides a scientific platform and a mechanism to create, modify and share waveforms and algorithms with a community.

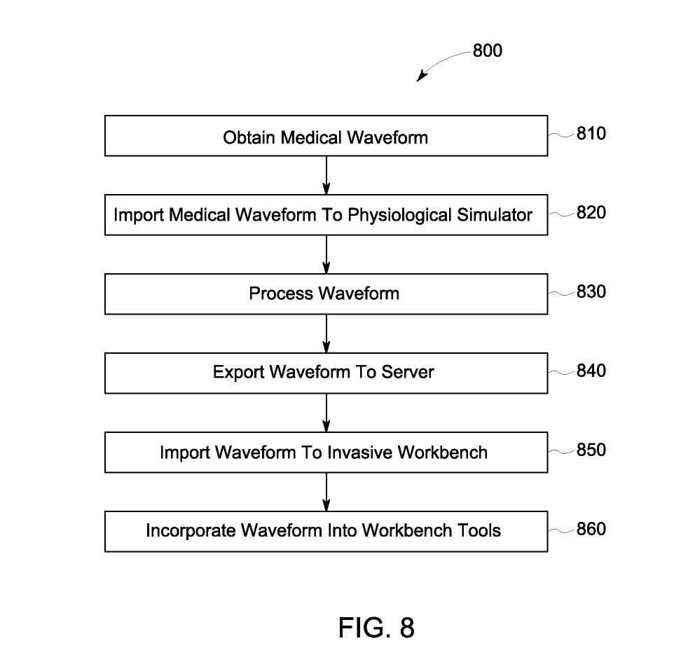

FIG. 8 depicts a flow diagram for a method for developing algorithms according to the present technology. In the first step 810 of the method, a medical waveform is obtained. The medical waveform may be obtained from a medical waveform recording system, such as medical waveform recording system 110 described herein. At step 820, that medical waveform is imported into a physiological simulator, such as physiological simulator 120 described herein. That medical waveform is then processed in step 830. Such processing can include cutting snippets from the medical waveform, combining multiple medical waveforms, creating looping medical waveforms and attaching other information such as patient data to a medical waveform, for example. At step 840, the processed medical waveforms are exported to a server, to a database or to a computer that can be accessed by a workbench, such as the invasive workbench 130 described herein. At step 850, the processed medical waveform is imported into the invasive workbench. At step 860, the medical waveform is incorporated into various tools of the invasive workbench, such as the algorithm development tool, the publishing tool, the statistical analysis tool or the literature search tool, for example.

The present technology described herein provides a unique and useful resource to assist electrophysiology development, research and training. Certain embodiments of the present technology provide the ability to create markers associated with the simulation files. The markers may be used to identify phases of the simulated data, such as the start and end of atrial fibrillation or the start and end of a pacing data set. The marker information can be used to show a high level outline of the content of the data set. In certain embodiments, a user would be able to start, stop or pause the waveform simulation replay at one, several or all of the data markers. The markers can be added by a user via the physiological simulator described herein. The markers can also be added, removed or modified by a user via the invasive workbench 130. This feature could be setup within a physiological waveform train and may or may not be linked to an event trigger. The event triggers can be activated via the invasive workbench when accessed by a user. For example, the event triggers can activate software programs such as medical training applications that pose questions and other training devices, word processing and publication tools to assist in publication of the user's work, research tools that allow a user to search for and access literature an other publications, statistical analysis tools allowing the user to analyze the presently viewed medical waveform, and an algorithm development tool, allowing a user to test algorithms in real time.

The present technology brings together a series of tools that can assist or guide a user with idea generation, development, validation, training and publication. The tools can include, but are not limited to the following examples.

A workbench framework that provides an invasive platform for working with recorded waveform signals. The workbench can be a single element of a larger research suite.

An algorithm plug-in or application that works in conjunction with the workbench framework and have access to physiological data that is shared and made available by the workbench framework. In certain embodiments, the algorithm plug-ins can also enable research.

A literature search engine that provides the capability to research technology, articles and other publications and allows the user to verify an idea/discovery as novel directly on the system.

A publication tool feature that provides the capability to create publication documents and integration with snapshots and signal waveform directly from the medical equipment (e.g., Mac-Lab/CardioLab), the framework, and algorithm plug-ins.

A statistical analysis tool that allows the user to analyze the waveforms and to categorize, sort, rank and compare the waveforms based on the statistical analysis.

The presently described physiological recording system, the physiological replay system, and the research suite on a single, integrated system defines a cardiac development methodology and provides the feedback mechanism necessary for the development methodology to take shape for clinical use. The methodology can produce innovations, publications, and validated hypothesis as output of the individual pieces of the system working in conjunction with each other. The output can then be used as input to the integrated system to develop clinically tested and FDA approved technology that will be used in the cardiac market for clinical use on patients.

The presently described technology provides many valuable advantages over the present state of the art. First, the present technology provides an ability to review real patient data stored on an electrophysiological recorder, and visually select waveform segments of interest.

The present technology also provides users with the ability to store, transport and relocate data of interest to a cardiac replay system. Users can chain or link cardiac cycle recordings to create synthetic waveform cases for replay, research and study.

The present technology also provides an ability to synchronize the cardiac replay data to educational materials (e.g., files Power Point files), or other media for educational purposes (learning, testing, training). The present technology provides an ability to synchronize cardiac replay data to stored radiographic, image data, ablation data.

Users of the present technology are also provided with the ability to set event triggers within the simulated waveform data to trigger other applications to execute user defined functions, such as displaying a power point slide, or to pose a question, or other interactive features whereby the user may insert data with contextual relevance.

The present technology provides an ability for user to create custom algorithms and test them on captured, or recorded waveform case data. This allows the user to explore the potential performance, optimizations and function of various algorithms relative to real physiological data and continue to evolve and test the algorithm of interest.

The present technology provides the ability to modify, and repetitively test algorithms with multiple data sets statically, and in real time as algorithm performance is proven. It also provides an ability to randomize case data following logical case trees (branching to different logical case states) to assist in user testing and training.

The present technology provides the ability to capture real patient case data, and allow a user to select, replay, and/or redirect the captured data in real time to a host computer to develop, test and prove new clinical algorithms.

The present technology provides the ability to insert aberrant data into captured waveforms, such as white noise, synthetic baseline wander, and electrical interference patterns to test algorithm performance. It also provides the ability to extract waveforms, and create case libraries for teaching, testing or research, and the ability to market and sell waveforms for research and teaching.

One element of the present technology provides a resource for reuse of captured cardiac or other physiological data. The present technology offers the ability to edit the data and to form complex formations, to synchronize events with other related anatomical data. This allows for simulation of synthetic patient case scenarios, which are invaluable for teaching, testing and training. The present technology also offers the ability to manipulate data to create challenging scenarios for training and teaching purposes.

The present technology also provides the ability to satisfy both teaching and research applications is within one system by offering a tool that supports algorithmic development using the acquired data. The ability to customize, tune and optimize algorithms within the framework of the physiological recorder in a non-patient environment, as described herein, allows reuse of patient data in the formative phases of cardiac algorithmic research. The present technology provides the ability to run a wide variety of test sets and scenarios to prove and optimize the algorithm for expert users, which can promote innovation. The presently described technology provides a single tool set and environment that supports both research applications, and training from one common data repository.

The present technology also provides the ability to select cardiac data or other medical data through an integrated system, to replay the data through the physiological recorder, and to support real time testing of custom algorithms developed in the invasive workbench. Using the presently described technology, users can create, test and refine algorithms within the workbench framework and then test the algorithms within a target environment using data sourced from the physiological recorder. A further advantage of the present technology includes the use of an established physiological recorder system providing a controlled, regulated patient care environment that remains fully functional, and unadulterated while simultaneously supporting a workflow enabling development of new and unproven algorithms for research applications.

The present technology has now been described in such full, clear, concise and exact terms as to enable any person skilled in the art to which it pertains, to practice the same. It is to be understood that the foregoing describes preferred embodiments and examples of the present technology and that modifications may be made therein without departing from the spirit or scope of the invention as set forth in the claims. Moreover, while particular elements, embodiments and applications of the present technology have been shown and described, it will be understood, of course, that the present technology is not limited thereto since modifications can be made by those skilled in the art without departing from the scope of the present disclosure, particularly in light of the foregoing teachings and appended claims. Moreover, it is also understood that the embodiments shown in the drawings, if any, and as described above are merely for illustrative purposes and not intended to limit the scope of the invention, which is defined by the following claims as interpreted according to the principles of patent law, including the Doctrine of Equivalents. Further, all references cited herein are incorporated in their entirety.

1. A medical waveform development system comprising:
a) a medical waveform recording system for obtaining recorded medical waveforms;
b) a physiological simulator for accessing said recorded medical waveforms obtained by the medical waveform recording system and for processing modified medical waveforms; and
c) an invasive workbench for allowing a user to access at least one of said recorded medical waveforms and said modified medical waveforms via at least one software application, said software application accessible on a computer.

2. The medical waveform development system of claim 1, wherein at least a portion of said modified medical waveforms comprise a medical waveform recorded by said medical waveform recording system.

3. The medical waveform development system of claim 1, wherein said recorded medical waveforms are cardiac waveforms.

4. The medical waveform development system of claim 3, wherein said recorded medical waveforms are electrocardiogram waveforms.

5. The medical waveform development system of claim 1, wherein said physiological simulator comprises a media transfer device for importing and exporting medical waveforms.

6. The medical waveform development system of claim 1, wherein said medical waveform recording system further obtains patient data related to said medical waveforms.

7. The medical waveform development system of claim 1, wherein physiological simulator allows for user modification of said recorded medical waveforms.

8. The medical waveform development system of claim 1, wherein said at least one software application comprises at least one of an algorithm development tool, a statistical analysis tool, a search tool and a publishing tool.

9. The medical waveform development system of claim 1, wherein said physiological simulator allows a user to add at least one marker to said recorded medical waveform, and wherein said at least one software application implements at least one event trigger when said medical waveform is accessed by said software application, said at least one event trigger corresponding to said at least one marker.

10. A method for developing medical waveforms comprising the following steps:
a) obtaining at least one medical waveform with a medical waveform recording system;
b) importing said at least one medical waveform into a physiological simulator,
c) processing said at least one medical waveform to generate at least one modified medical waveform;
d) exporting said at least one modified medical waveform to a storage location;
e) accessing said at least one modified medical waveform via an invasive workbench; and
f) implementing said at least one modified medical waveform into at least one software application operated by said invasive workbench.

11. The method of claim 10, wherein said at least one modified medical waveform comprises at least one medical waveform recorded by said medical waveform recording system.

12. The method of claim 11, wherein said at least one modified medical waveform comprises at least two distinct medical waveforms recorded by said medical waveform recording system.

13. The method of claim 10, wherein said at least one medical waveform is a cardiac waveform.

14. The method of claim 10, wherein said at least one software application comprises at least one of an algorithm development tool, a statistical analysis tool, a search tool and a publishing tool.

15. The method of claim 10, wherein said processing step further includes adding at least one marker to said modified medical waveform.

16. The method of claim 10, wherein said at least one software application comprises at least one of an algorithm development tool, a statistical analysis tool, a search tool and a publishing tool and wherein said software application implements at least one event trigger when said medical waveform is accessed by said software application, said at least one event trigger corresponding to said at least one marker.

17. The method of claim 10, wherein said obtaining at least one medical waveform step further comprises obtaining patient data related to said medical waveforms.

18. A medical waveform development system comprising:
a) a physiological simulator comprising an input for receiving recorded medical obtained by a medical waveform recording system, said physiological simulator allowing for user modification of said recorded medical waveforms; and
an invasive workbench for allowing a user to access at least one of said recorded medical waveforms and said modified medical waveforms via at least one software application, said software application accessible on a computer;
wherein said physiological simulator comprises a media transfer device for importing and exporting medical waveforms.

19. The medical waveform development system of claim 18, wherein said medical waveforms are cardiac waveforms.

20. The medical waveform development system of claim 18, wherein said at least one software application comprises at least one of an algorithm development tool, a statistical analysis tool, a search tool and a publishing tool, and wherein said physiological simulator allows a user to add at least one marker to said recorded medical waveform, further wherein said at least one software application implements at least one event trigger when said medical waveform is accessed by said software application, said at least one event trigger corresponding to said at least one marker.
